(19) United States
(12) Patent Application Publication
(10) Pub. No.: US 2011/0167872 A1
(43) Pub. Date: Jul. 14, 2011

(54) Method for Manufacturing Molded Glass Body

(76) Inventors: Kazuyuki Ogura, Osaka (JP); Yoshihiro Kamada, Osaka (JP)

(21) Appl. No.: 13/119,427

(22) PCT Filed: Sep. 10, 2009
(86) PCT No.: PCT/JP2009/065815

§ 371 Date: Mar. 16, 2011

(30) Foreign Application Priority Data
Sep. 20, 2008 (JP) 2008-241886

(51) Int. Cl. C03B 11/00; C03B 11/16; C03B 11/06

(52) U.S. Cl. 65/66; 65/102

(57) ABSTRACT

There is provided a method of manufacturing a molded glass body, wherein, in a mold-releasing step of releasing and withdrawing a molded body obtained after pressure-molding, from molds, relative positions of an upper mold and a lower mold are moved to take a retracting position at which, even if the molded glass body which has stuck on the upper mold falls down from the upper mold, the molded glass body does not fall on the lower mold. Thus, even if the molded body falls down from the upper mold, the molded glass body does not damage the lower mold.

### TECHNICAL FIELD

The present invention relates to a method of manufacturing a molded glass body, and particularly to a method of manufacturing a molded glass body employing a molding step of pressure-molding a glass precursor by using an upper mold and a lower mold to obtain a molded glass body.

### BACKGROUND ART

There are used many molded glass bodies manufactured by pressure-molding a glass material with molds, as optical elements for various optical devices such as a lens for a digital camera, an optical pickup lens for DVDs, a camera lens for a cell phone, and a coupling lens for an optical communication. A required level of molded glass bodies to be employed as such the optical elements is becoming much more higher, corresponding to the recent trend toward smaller-sized and higher-accurate optical products.

As a manufacturing method of such the molded glass body, there is known a method (for example, refer to Patent Literature 1) to previously prepare a glass preform having a predetermined mass and predetermined shape and to pressure-mold the glass preform by heating the glass preform with moldings (hereinafter, it is referred as a reheat pressing method).

On the other hand, as another method of manufacturing the molded glass body, there is known a method (for example, refer to Patent Literature 2) to drip a drop of molten glass on a mold whose temperature is kept to a predetermined temperature being lower than that of the drop of molten glass and to pressure-mold the drop with the molds before the drop of molten glass which has been dripped is cooled and solidified (hereinafter, it is referred as a liquid-drop molding method).

### CITATION LIST

### Patent Literature

Patent literature 1: JP-A No. 2001-80924
Patent literature 2: JP-A No. 2007-186358

### SUMMARY OF INVENTION

### Technical Problem

However, because the liquid-drop molding method is a method to pressure-mold the drop before the drop of molten glass which has been dripped is cooled and solidified, the temperature of the drop of molten glass only falls rapidly because of heat radiation from its surface which touches the molds. Therefore, it is very hard to control the glass temperature artificially with accuracy under a pressing process.

Therefore, it is very hard to control surely which of the upper mold or the lower mold the molded glass body sticks on, and is hard to control surely the degrees of stick strength to respective molds. Therefore, if the molded glass body sticks on the upper mold and its stick strength is weak, the molded glass body can fall down from the upper mold during a period from the end of pressure molding to releasing and withdrawing the molded glass body from the mold, and the molded glass body can strike and damage the lower mold which is placed directly under the upper mold, which can be a problem. Because the damaged lower mold cannot be used to the manufacturing process as it is, the lower mold is required to be replaced, which significantly deteriorates its productivity because of an operation stop for replacing the lower mold and causes problems such as cost increase of the lower mold.

In the reheat press method, it is relatively easy to control which of the upper mold or lower mold the molded glass body sticks on, and to control the degrees of stick strength to respective molds, by controlling temperature of the mold in the molding operation or in cooling operation. However, the possibility that problems being similar to those of the drop molding method can be caused is not nil

The present invention is achieved in view of the above circumstances, and aims to provide a method of manufacturing a molded glass body wherein, in a mold-releasing step of releasing and withdrawing the molded body obtained after pressure-molding, from molds, the molded glass body does not damage the lower mold, even if the molded glass body which has stuck on the upper mold falls down before it is released and withdrawn from the mold.

### Solution to Problem

An object of the present invention will be achieved by the followings.

1. A method of manufacturing a molded glass body, comprising a molding step of pressure-molding a glass precursor with an upper mold and a lower mold to obtain a molded glass body, the method characterized by further comprising: a mold-releasing step of withdrawing the molded glass body which has stuck on one of the upper mold and the lower mold by using a mold-releasing means, after at least one of the upper mold and the lower mold is moved in a first direction which increases a distance between the upper mold and the lower mold after the molding step has been completed,

wherein the mold-releasing step comprises a retracting step of moving at least one of the upper mold and the lower mold to a retracting position, in order to place the upper mold and the lower mold at relative positions such that, even if the molded glass body which has stuck on the upper mold falls down, the molded glass body does not fall down on the lower mold.

2. The method of a manufacturing a molded glass body of Item 1, characterized in that the retracting position is a position located along a second direction which is perpendicular to at least the first direction.

3. The method of a manufacturing a molded glass body of Item 1 or 2, characterized in that the lower mold is movable to one from another among a glass-precursor-loading position where the glass precursor is loaded thereon, a pressing position where the glass precursor is pressure-molded in the molding step, and the retracting position, sequentially in this order.

4. The method of a manufacturing molded glass body of Item 3, characterized in that the retracting position is located along a second direction which is perpendicular to at least the first direction, and is located at a position between the glass-precursor-loading position and the pressing position.

5. The method of a manufacturing molded glass body of Item 4, characterized in that the lower mold moves from the pressing position to the glass-precursor-loading position without stopping at the retracting position.

6. The method of manufacturing a molded glass body of Item 3, characterized in that the retracting position is located along a second direction which is perpendicular to at least the first direction, and is located at a position opposite to the glass-precursor-loading position across the pressing position.

7. The method of manufacturing a molded glass body of any one of Items 1 to 6, characterized in that a movement of relative positions of the upper mold and the lower mold in the retracting step starts, before a movement of the at least one of the upper mold and the lower mold in the first direction in the mold-releasing step is completed.

8. The method of manufacturing a molded glass body of Item 7, characterized in that in the retracting step, the movement of the relative positions of the upper mold and the lower mold starts, after a relative distance along the first direction between the upper mold and the lower mold in the mold-releasing step becomes a predetermined value or more.

9. The method of manufacturing a molded glass body of Item 8, characterized in that the predetermined value is larger than a thickness of the molded glass body.

10. The method of manufacturing a molded glass body of any one of Items 1 to 9, characterized in that the glass precursor is a drop of molten glass which falls on the lower mold.

11. The method of manufacturing a molded glass body of any one of Items 1 to 9, characterized in that the glass precursor is a glass preform having a predetermined mass and a predetermined shape.

### Advantageous Effects of Invention

According to the present invention, there can be provided a method of manufacturing a molded glass body, wherein, in a mold-releasing step of releasing and withdrawing a molded body obtained after pressure-molding from molds, relative positions of the upper mold and the lower mold is moved to take a retracting position where, even if the glass molded body which has stack on the upper mold falls down from the upper mold, the molded glass body does not fall down on the lower mold. Thereby, if the molded body falls down from the upper mold, it does not damage the lower mold.

### BRIEF DESCRIPTION OF DRAWINGS

FIG. 1 shows a schematic view illustrating a structure and operations of a device for manufacturing molded glass bodies relating to an embodiment of the present invention.

FIG. 2 shows a flowchart illustrating operations of the embodiment of the present invention.

FIG. 3 shows a schematic view illustrating conditions of respective steps in FIG. 2.

FIG. 4 shows a schematic view illustrating a structure and operations of a conventional device for manufacturing molded glass bodies.

FIG. 5 shows a schematic view illustrating conventional operations and problems.

### DESCRIPTION OF EMBODIMENTS

The present invention will be described below based on the illustrated embodiment However, the scope of the invention is not limited to the embodiment. In the drawings, the same or similar portions will be numbered by the same numbers and duplicable descriptions will be omitted.

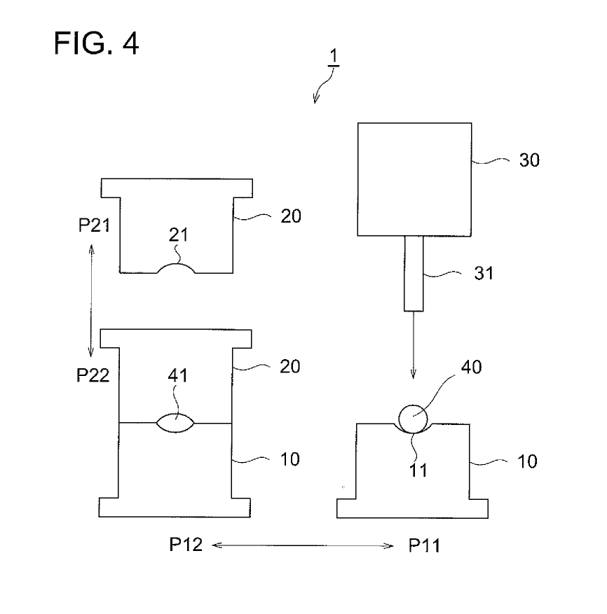

First, the structure and operations of a conventional manufacturing device of molded glass bodies will be described with referring to FIG. 4. FIG. 4 shows a schematic view illustrating a structure and operations of a conventional device for manufacturing molded glass bodies.

In FIG. 4, device for manufacturing molded glass bodies 1 is a manufacturing apparatus for use in the above-described liquid-drop molding method, and is composed of melting tank 30 for storing molten glass, dripping nozzle 31 connected to the lower portion of melting tank 30, lower mold 10 for receiving drop of molten glass 40, and upper mold 20 for pressing drop of molten glass 40 together with lower mold 10.

Lower mold 10 is structured to be movable by an unillustrated drive means in the horizontal direction between a position for receiving drop of molten glass 40 under dripping nozzle 31 (dripping position P11) and a position for facing upper mold 20 to perform the pressure-molding of drop of molten glass 40 (pressing position P12).

Upper mold 20 is structured to be movable by an unillustrated drive means in the vertical direction between a position for waiting before and after the pressure-molding operation (standby position P21) and a position for facing lower mold 10 to perform of the pressure-molding of drop of molten glass 40 (pressing position P22).

Next, its operations will be described. Lower mold 10 moves to dripping position P11, then, molten glass stored in melting tank 30 falls down through dripping nozzle 31 connected to the lower portion of melting tank 30 onto molding surface 11 of lower mold 10, to form drop of molten glass 40.

Lower mold 10 which has received drop of molten glass 40 moves to pressing position P22, then, upper mold 20 goes down from standby position P21 to pressing position P22. Drop of molten glass 40 is pressure-molded between molding surface 21 of upper mold 20 and molding surface 11 of lower mold 10, and molded glass body 41 is obtained. After the pressure-molding is completed, upper mold goes up to standby position P21 and molded glass body 41 is withdrawn.

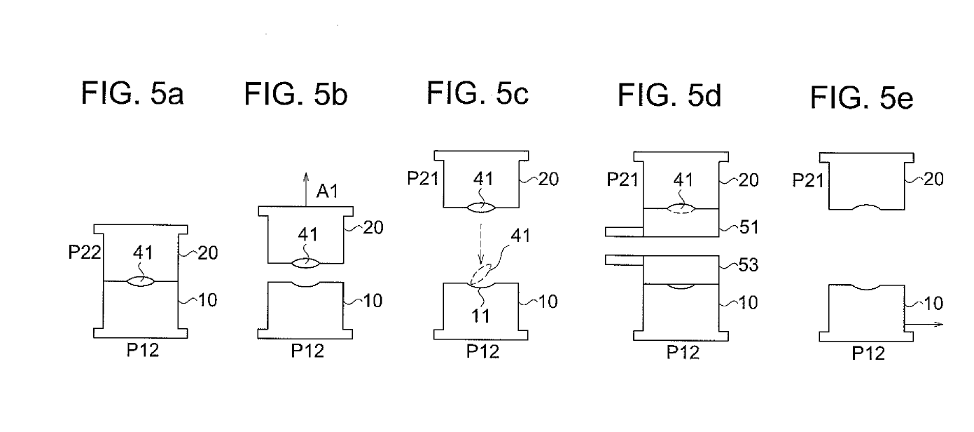

Next, the problems to be solved in the present invention will be confirmed with referring to FIG. 5. FIG. 5 is a diagram for confirming the problems to be solved in the present invention, and is a schematic view illustrating conventional operations and their problem during a period that molded glass body 41 is withdrawn after the pressure-molding is completed until the method moves to the next pressure-molding operation.

When pressure-molding of molded glass body 41 with upper mold 20 and lower mold 10 has been completed as shown in FIG. 5a, upper mold 20 starts moving from pressing position P22 in first direction A1 which is a direction increasing the distance between the upper mold and lower mold as shown in FIG. 5b, in other words, the upper direction in the figure. At that time, which of the upper mold 20 and the lower mold 10 molded glass body 41 sticks on, depends on conditions such as variations of molding pressure and molding temperature, and surface conditions of molding surface 21 of upper mold 20 and molding surface 11 of lower mold 10. It is difficult to set proper conditions by which the molded glass body always sticks on either of them. In FIG. 5b, it is assumed that the molded glass body sticks on upper mold 20.

When upper mold 20 reaches at standby position P21 and stops as shown in FIG. 5c, mold-releasing anus 51 and 53 for withdrawing molded glass body 41 are inserted into positions facing molding surface 21 of upper mold 20 and molding surface 11 of lower mold 11, respectively, and the molded glass body 41 is withdrawn as shown in FIG. 5d.

When withdrawing of molded glass body 41 is completed as shown in FIG. 5e, a series of operations is finished. If the method moves to the next operations of manufacturing a molded glass body immediately, lower mold 10 starts moving from pressing position P12 toward dripping position P11.

At that time, if molded glass body 41 which has stuck on upper mold 20 comes off, during a period from the completion of the pressure-molding in FIG. 5a to withdrawing molded glass body in FIG. 5d, it causes an accident that for example, molded glass body 41 falls down on molding surface 11 of lower mold 10 as illustrated by broken lines in FIG. 5c and damages the molding surface 11. When withdrawing molded glass body 41 results in failure in FIG. 5d, the similar accident is caused. Those are problems to be solved in the present invention.

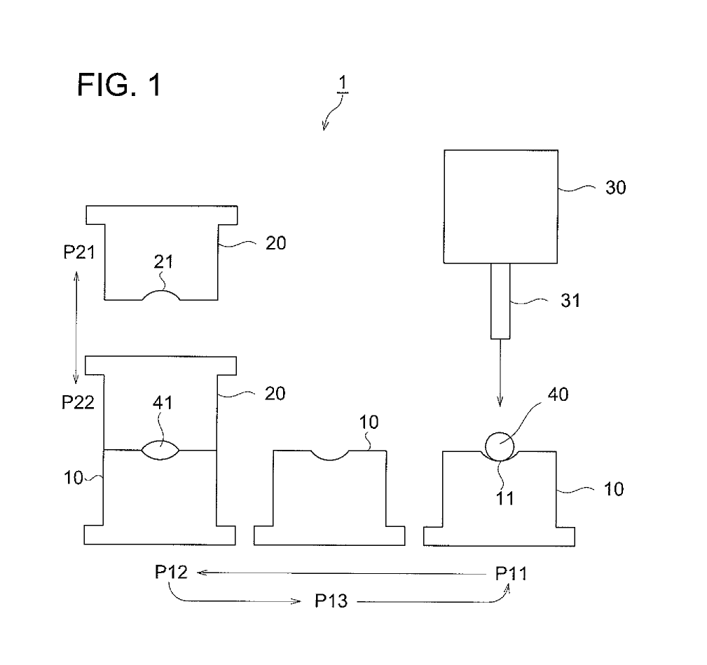

Next, the structure and operations of a device for manufacturing molded glass bodies in an embodiment of the present invention will be described with referring to FIG. 1. FIG. 1 shows a schematic view illustrating the structure and operations of a device for manufacturing molded glass bodies in an embodiment of the present invention.

In FIG. 1, device for manufacturing molded glass bodies 1 is a manufacturing apparatus for use in the liquid-drop molding method which is similar to that shown in FIG. 4, and is composed of melting tank 30 for storing molten glass, dripping nozzle 31 connected to the lower portion of melting tank 30, lower mold 10 for receiving drop of molten glass 40, and upper mold 20 for pressing drop of molten glass 40 together with lower mold 10.

Lower mold 10 is structured to be movable by an unillustrated drive means in the horizontal direction from one to another among a position for receiving drop of molten glass 40 under dripping nozzle 31 (dripping position P11), a position for facing upper mold 20 to perform of the pressure-molding of drop of molten glass 40 (pressing position P12), and retracting position P13 arranged between dripping position P11 and pressing position 12.

In this situation, drop of molten glass 40 corresponds to a glass precursor of the present invention, and dripping position P11 corresponds to a glass-precursor-loading position of the present invention.

Upper mold 20 is structured to be movable by an unillustrated drive means in the vertical direction between a position for waiting before and after the pressure-molding (standby position P21) and a position for facing lower mold 10 to perform the pressure-molding of drop of molten glass 40 (pressing position P22).

The embodiment employs a structure that only upper mold 20 moves in a pressing direction, but the scope of the present invention is not limited to that. It may employ a structure that upper mold 20 is fixed and only lower mold 20 moves in the pressing direction, or a structure that both lower mold 10 and upper mold 20 move.

Material of lower mold 10 and upper mold 20 can be selected properly from the following well-known materials for a mold for pressure-molding a molded glass body: heat-resistant alloys (such as stainless steel), superhard materials based on tungsten carbide, various ceramics (such as silicon carbide, silicon nitride, and aluminium nitride), composite materials including carbon. Lower mold 10 and upper mold 20 can be formed of the same material, or of different materials from each other.

Further, it is preferable that coating layers are deposited on at least molding surfaces 11 and 12, for enhancing durability of lower mold 10 and upper mold 20 and preventing them from fusing to drop of molten glass 40. Material of the coating layers is not especially limited, too, and for example, the followings can be used: various metals (such as chrome, aluminium, and titanium), nitrides (chrome nitride, aluminium nitride, titanium nitride, and boron nitride), and oxides (chrome oxide, aluminium oxide, and titanium oxide). The method of forming the coating layers is not limited, too, and can be selected properly from well-known methods of forming layers. For example, there can be cited vacuum deposition, spattering, and CVD.

Lower mold 10 and upper mold 20 are structured to be heated to a predetermined temperature with a heating means which is not illustrated. A heating means can be selected from well-known heating means properly. For example, there can be used a cartridge heater which is used with being embedded inside of a member to be heated, a sheet-type heater which is used with touching with the outside of a member to be heated, infrared heater, and high-frequency induction heater.

Further, the point where the operations of the embodiment of the present invention differ from the conventional operations is described below. In the conventional operations, lower mold 10 moves only between dripping position P11 and pressing position P12. On the other hand, in the operations of the embodiment of the present invention, lower mold 10 moves from dripping position P11 to pressing position P12, moves from pressing position P12 to retracting position P13, and moves from retreating position P13 to dripping position P11, to form an one-way cycle.

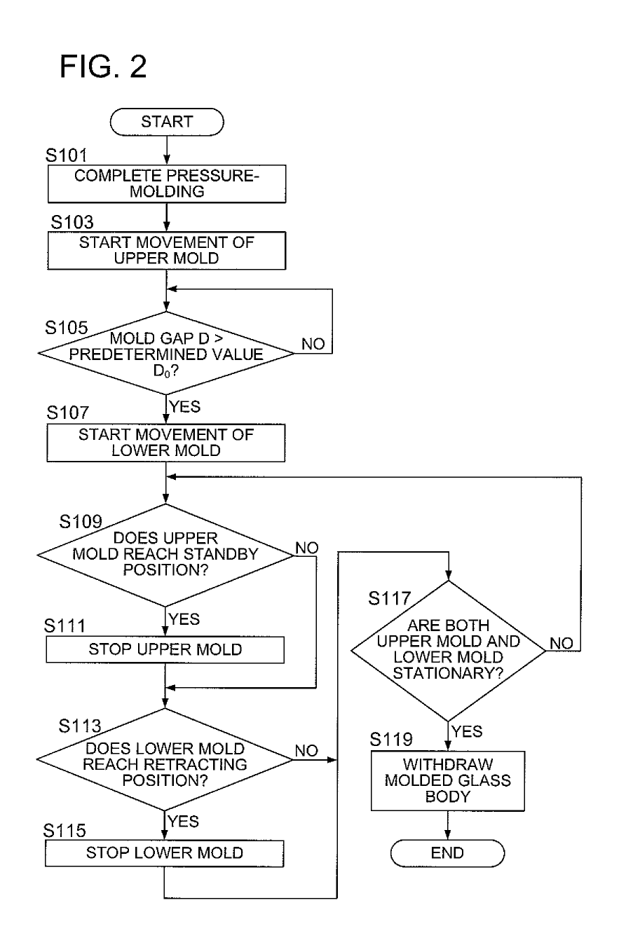

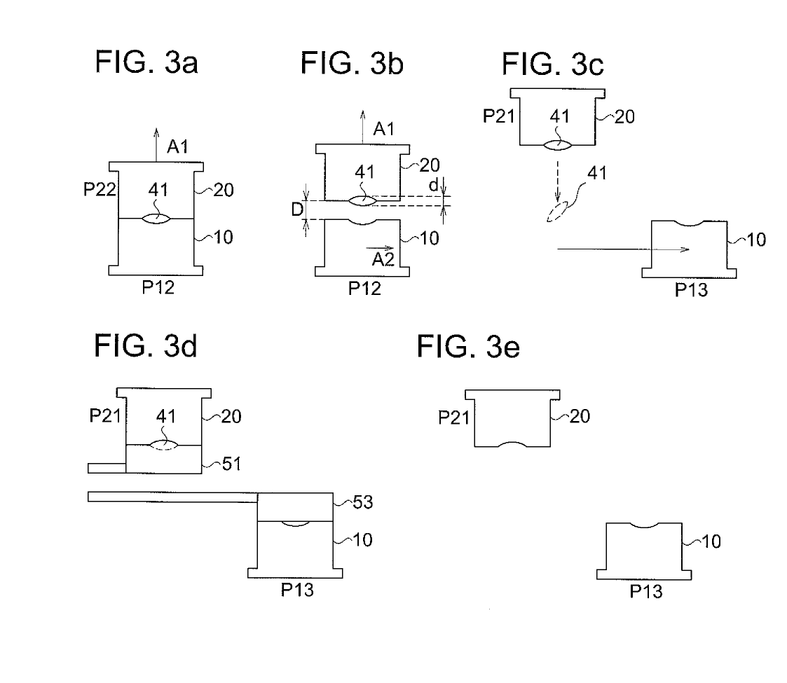

Next, the operations of the embodiment of the present invention will be described in detail, with referring to FIGS. 2 and 3. FIG. 2 shows a flowchart illustrating operations during a period that molded glass body 41 is withdrawn after the pressure-molding is completed until the method moves to the next pressure-molding operation, in the embodiment of the present invention. FIG. 3 shows a schematic view illustrating conditions of respective steps in FIG. 2.

In FIG. 2, when pressure molding has been completed in step S101 (corresponding to the condition in FIG. 3a), upper mold 20 starts moving from pressing position P22 in first direction A1 that is a direction increasing the distance between the upper mold and the lower mold as shown in FIG. 3a, namely mold-releasing direction in step S103, that is, the upper mold starts moving upward in the figure. In step S105, it is checked whether gap D between upper mold 20 and lower mold 10 becomes larger than predetermined value D0 or not.

As the way to check gap D, known methods such as a measurement using a position sensor, and a mathematic operation based on counting of the number of steps of a step motor, can be employed and it is not especially limited. Predetermined value D0 is a value determined such that, even if lower mold 10 moves in the operations after step S107, lower mold 10 does not strike molded glass body 41. For example, the value is greater than thickness d of molded glass body 41.

The operations are on standby at step S105 until gap D between upper mold 20 and lower mold 10 becomes greater than predetermined value D0, and move to step S107 when it becomes greater than the value (step S105; Yes). In step S107, lower mold 10 starts moving along second direction A2 which is perpendicular to first direction A1 shown in FIG. 3b, that is, starts moving rightward in the figure. In other words, lower mold 10 stars moving along second direction A2 before the movement of upper mold 20 to standby position P21 is completed.

In step S109, it is checked whether upper mold 20 reaches standby position P21 or not. As the way to check that, known methods such as a measurement using a position sensor, a mathematic operation based on counting of the number of steps of a step motor, and working of a position switch, can be employed and it is not especially limited.

If upper mold 20 reaches standby position P21 (step S109; Yes), the movement of upper mold 20 is stopped in step S111 and the method moves to step S113. If upper mold 21 does not reach standby position 21 (step S109; No), the method moves to step S113, too.

It is checked whether lower mold 10 reaches retracting position P13 shown in FIG. 3c or not, in step S113. As the way to check that, known methods such as a measurement using a position sensor, a mathematic operation based on counting the number of steps of a step motor, and working of a position switch, can be employed and it is not especially limited. Retracting position P13 is located at a position between dripping position P11 and pressing position P12, and is located at a position such that, for example, when molded glass body 41 which has fallen down from upper mold 20 and is illustrated by broken lines in FIG. 3c drops on molding surface 11 of lower mold 10, molded glass body 41 does not damage molding surface 11.

If lower mold 10 reaches retracting position P13 (step S113; Yes), the movement of lower mold 10 is stopped in step S115, and the method moves to step S117. If lower mold 10 does not reach retracting position P13 (step S113; No), the method moves to step S117, too.

It is checked whether both upper mold 20 and lower mold 10 reach is stationary, in step S117. When at least one of them is not stationary (step S117; No), the method returns to step S109 and operations from step S109 to step S117 are repeated.

If both upper mold 20 and lower mold 10 are stationary (step S117; Yes), mold-releasing arms 51 and 53 are inserted into positions to face molding surface 21 of upper mold 20 and molding surface 11 of lower mold 10, respectively, similarly to FIG. 5d, and molded glass body 41 is withdrawn (corresponding to the condition shown in FIG. 3d). Herein, mold-releasing arms 51 and 53 are withdrawing devices for withdrawing molded glass body 41 by a method to suck the body by, for example, vacuum chuck, and correspond to a mold-releasing means in the present invention.

When withdrawing molded glass body 41 is completed in step S119, a series of operations is finished. At that time, lower mold 10 still positions at retracting position P13. If the method moves to the next manufacturing operations of a molded glass body immediately, the movement of lower mold 10 from retracting position P13 toward dripping position P11 starts. Herein, operations from step S103 to S119 work as a mold-releasing step in the present invention, and operations of step S107, step S113 and step S115 work as a retracting step in the present invention.

Incidentally, retracting position P13 has been arranged at a position between dripping position P11 and pressing position P12 in the above descriptions. However, if there is a structural difficulty of the apparatus, retracting position P13 may be located at a position opposite to dripping position P11 across pressing position P12 (at the left-hand side of FIG. 1). In this case, when the method moves to the next manufacturing step of a molded glass body immediately, it is preferable in view of reduction of tact time of manufacture that, after withdrawing molded glass body 41 in step S119 has been completed, lower mold 10 is once returned from retracting position P13 to pressing position P12 and lower mold 10 is moved to dripping position P11 based on pressing position P12 as a reference position.

As described above, according to the present invention, in the mold-releasing step of releasing and withdrawing the molded body obtained after pressure-molding from molds, the lower mold moves along the second direction which is perpendicular to at least the first direction that is a direction increasing the distance between the upper mold and the lower mold, namely the mold-releasing direction, and moves to the retracting position which is located at a position between the dripping position and the pressing position and is arranged at a position such that, even if the molded glass body falls down from the upper mold, the body does not damage the molding surface of the lower mold. Thereby, a method of manufacturing a molded glass body can be provided, wherein, even if the molded glass body which has stuck on the upper mold falls down in the mold-releasing step, the molded glass body does not damage the lower mold.

Further, because the retracting position of the Tower mold is arranged at a position between the dripping position and the pressing position, time required to move the lower mold to the dripping position can be saved when the method moves to the next operation of manufacturing a molded glass body, which contributes to the reduction of tact time of the manufacture. Compared with the fact that the movement of the lower mold started after the mold-releasing step was completed in the conventional operations, that contributes to the reduction of tact time, in the point that the movement of the lower mold starts in the middle of the movement of the upper mold to the standby position. When it is required to further reduce the tact time of the manufacturing, the lower mold may moves immediately to the dripping position without stopping at the retracting position.

In the above embodiment, the manufacturing apparatus used for a liquid-drop molding method has been described. However, the scope of the invention is not limited to that and it can be applied to a reheat pressing method. In that case, melting tank 30 and dripping nozzle 31 should be replaced to a glass-preform-supplying section for supplying a glass preform corresponding to a glass precursor in the present invention, on the lower mold.

As described above, according to the present invention, there can be provided a method of manufacturing a molded glass body wherein, in the mold-releasing step of releasing and withdrawing a molded body obtained after pressure-molding from molds, relative positions of the upper mold and the lower mold moves to take the retracting position such that, even if the molded glass body falls down from the upper mold, the body does not damage the molding surface of the lower mold. Thereby, even if the molded glass body which has stuck on the upper mold falls down, the molded glass body does not damage the lower mold.

Detailed structures of components constructing the method of manufacturing a molded glass body relating to the present invention, and their detailed operations may be modified unless otherwise such modifications depart from the scope of the present invention.

### REFERENCE SIGNS LIST

1 Device for manufacturing molded glass bodies
10 Lower mold
11 Molding surface (of lower mold 10)
20 Upper mold
21 Molding surface (of upper mold 20)
30 Melting tank
31 Dripping nozzle
40 Drop of molten glass
41 Molded glass body
51 Mold-releasing arm
53 Mold-releasing aim
A1 First direction (direction increasing the distance between the upper and lower molds)
A2 Second direction (perpendicular to first direction A1)
D Gap
D0 Predetermined value
d Thickness (of molded glass body 41)
P11 Dripping position
P12 Pressing position
P13 Retracting position
P21 Standby position
P22 Pressing position

1. A method of manufacturing a molded glass body, comprising a molding step of pressure-molding a glass precursor with an upper mold and a lower mold to obtain a molded glass body, and
a mold-releasing step of withdrawing the molded glass body which has stuck on one of the upper mold and the lower mold by using a mold-releasing means, after at least one of the upper mold and the lower mold is moved in a first direction which increases a distance between the upper mold and the lower mold after the molding step has been completed,
wherein the mold-releasing step comprises a retracting step of moving the lower mold to a retracting position, in order to place the upper mold and the lower mold at positions such that, even if the molded glass body which has stuck on the upper mold falls down, the molded glass body does not fall down on the lower mold,
the lower mold is movable to one from another among a glass-precursor-loading position where the glass precursor is loaded thereon, a pressing position where the glass precursor is pressure-molded in the molding step, and the retracting position, and
the retracting position is located at a position between the glass-precursor-loading position and the pressing position.

2. The method of a manufacturing a molded glass body of claim 1,
wherein the retracting position is a position located along a second direction which is perpendicular to at least the first direction.

3. The method of a manufacturing a molded glass body of claim 1,
wherein the lower mold is movable to one from another among the glass-precursor-loading position, the pressing position, and the retracting position, sequentially in this order.

4. (canceled)

5. The method of a manufacturing molded glass body of claim 3,
wherein the lower mold moves from the pressing position to the glass-precursor-loading position without stopping at the retracting position.

6. The method of manufacturing a molded glass body of claim 1,
wherein the retracting position is located along a second direction which is perpendicular to at least the first direction, and is located at a position opposite to the glass-precursor-loading position across the pressing position.

7. The method of manufacturing a molded glass body of claim 1,
wherein a movement of the lower mold in the retracting step starts, before a movement of the at least one of the upper mold and the lower mold in the first direction in the mold-releasing step is completed.

8. The method of manufacturing a molded glass body of claim 7,
wherein in the retracting step, the movement of the lower mold starts, after a relative distance along the first direction between the upper mold and the lower mold in the mold-releasing step becomes a predetermined value or more.

9. The method of manufacturing a molded glass body of claim 8,
wherein the predetermined value is larger than a thickness of the molded glass body.

10. The method of manufacturing a molded glass body of claim 1,
wherein the glass precursor is a drop of molten glass which falls on the lower mold.

11. The method of manufacturing a molded glass body of claim 1,
wherein the glass precursor is a glass preform having a predetermined mass and a predetermined shape.
